(19) United States
(12) Patent Application Publication
(10) Pub. No.: US 2026/0222510 A1
(43) Pub. Date: Jul. 30, 2026

(54) IMAGE COMPRESSION DEVICE, IMAGE FORMING APPARATUS, EXAMINATION APPARATUS, IMAGE COMPRESSION METHOD, AND RECORDING MEDIUM

(71) Applicant: Kazuki ISHIKURA, Kanagawa (JP)

(72) Inventor: Kazuki ISHIKURA, Kanagawa (JP)

(21) Appl. No.: 19/145,541

(22) PCT Filed: Jan. 23, 2024
(86) PCT No.: PCT/IB2024/050611

§ 371 Date: Jul. 3, 2025

(30) Foreign Application Priority Data
Jan. 31, 2023 (JP) 2023-013552
Dec. 5, 2023 (JP) 2023-205681

(51) Int. Cl. H04N 1/41; H04N 19/124; H04N 19/186

(52) U.S. Cl. CPC H04N 1/41; H04N 19/124; H04N 19/186

(57) ABSTRACT

An image compression device includes: a compression unit configured to receive image data and parameters for use in compression, and perform compression processing on the image data based on information on the image data and the parameters using a quantization table for a brightness signal and a quantization table for a color signal; and a parameter setting unit configured to set the parameters in the compression unit, wherein the parameter setting unit sets an upper limit of the parameters of the quantization table for the color signal to a value that is less than or equal to α, and sets 90% or more of the parameters of AC components of the quantization table for the brightness signal to have values that are greater than or equal to the respective parameters of AC components of the quantization table for the color signal.

### TECHNICAL FIELD

The present disclosure relates to an image compression device, an image forming apparatus, an examination apparatus, an image compression method, and a recording medium.

### BACKGROUND ART

In the related art, a technique is disclosed in which a text area and a background area of a read image of a document or the like are compressed using different quantization tables in order to increase the compression effect of the read image.

### CITATION LIST

### Patent Literature

### [PTL 1]

Japanese Unexamined Patent Application Publication No. 2009-060474

### SUMMARY OF INVENTION

### Technical Problem

The use of different quantization tables for a text area and a background area of an image as in the technique of the related art is a special compression formant. Thus, this compression format is not usable in generic optical character recognition/reader (OCR) processing software.

In the technique of the related art, compression of a color signal (color difference) is considered. However, compression of a brightness signal is not considered. Thus, a sufficient compression effect is not expectable.

### Solution to Problem

According to an embodiment of the present invention, an image compression device includes a compression unit configured to receive image data and parameters for use in compression, and perform compression processing on the image data based on information on the image data and the parameters using a quantization table for a brightness signal and a quantization table for a color signal; and a parameter setting unit configured to set the parameters in the compression unit, in which the parameter setting unit sets an upper limit of the parameters of the quantization table for the color signal to a value that is less than or equal to α, and sets 90% or more of the parameters of AC components of the quantization table for the brightness signal to have values that are greater than or equal to the respective parameters of AC components of the quantization table for the color signal.

According to an embodiment of the present invention, an image forming apparatus includes the above-described image compression device, and an image forming unit configured to print image data compressed by the image compression device.

According to an embodiment of the present invention, an examination apparatus includes the above-described image compression device.

According to an embodiment of the present invention, an image compression method includes receiving image data and parameters for use in compression; performing compression processing on the image data based on information on the image data and the parameters using a quantization table for a brightness signal and a quantization table for a color signal; and setting the parameters. The setting includes setting an upper limit of the parameters of the quantization table for the color signal to a value that is less than or equal to α, and setting 90% or more of the parameters of AC components of the quantization table for the brightness signal to have values that are greater than or equal to the respective parameters of AC components of the quantization table for the color signal.

According to an embodiment of the present invention, a recording medium stores a program which causes a computer to perform the above-described image compression method.

### Advantageous Effects of Invention

According to at least one embodiment of the present disclosure, a generic compressed image that implements both an increased compression efficiency and an increased OCR processing accuracy can be generated.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a diagram illustrating a configuration of an image forming apparatus according to a first embodiment.

FIG. 2 is a block diagram illustrating an example of a hardware configuration of the image forming apparatus illustrated in FIG. 1.

FIG. 3 is a block diagram illustrating an example of a functional configuration of the image forming apparatus illustrated in FIG. 1.

FIG. 4 is a block diagram illustrating a functional configuration of an image compression device.

FIG. 5A is a diagram schematically illustrating a quantization table.

FIG. 5B is a diagram schematically illustrating a quantization table.

FIG. 6 is a diagram illustrating an 8×8 pixel block of a black text portion.

FIG. 7A is a diagram illustrating a frequency component of a color signal for the 8×8 pixel block of the black text portion.

FIG. 7B is a diagram illustrating red (R), green (G), and blue (B) values of the color signal for the 8×8 pixel block of the black text portion.

FIGS. 8A and 8B are diagrams illustrating an example of compression using a quantization table of a low compression ratio.

FIG. 9A is a diagram schematically illustrating another quantization table.

FIG. 9B is a diagram schematically illustrating another quantization table.

FIG. 10A is a flowchart illustrating image compression processing performed by the image compression device according to the first embodiment.

FIG. 10B is a flowchart illustrating parameter setting processing.

FIG. 11 is a block diagram illustrating a functional configuration of an image compression device according to a second embodiment.

FIGS. 12A to 12C are diagrams illustrating an example of generation of parameters.

FIG. 13A to 13D are diagrams illustrating an example of correcting the quantization table in generation of parameters.

FIG. 14 is a diagram illustrating sub-sampling processing performed by an image compression device according to a third embodiment.

FIG. 15 is a diagram illustrating diagnostic imaging processing in an examination apparatus according to a fourth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below.

As used herein, the singular forms “a,” “an,” and “the” are intended to include the plural forms as well, unless the context clearly indicates otherwise.

An image compression device, an image forming apparatus, an examination apparatus, an image compression method, and a program recorded on a recording medium according to embodiments will be described in detail below with reference to the accompanying drawings.

Description will be given below of an example in which the image forming apparatus according to embodiments of the present disclosure is applied to a multifunction peripheral having at least two functions among a copy function, a printer function, a scanner function, and a facsimile function. However, an apparatus to which the image forming apparatus according to the embodiments of the present disclosure is applicable is not limited to the multifunction peripheral. For example, the image forming apparatus according to the embodiments of the present disclosure is also applicable to image forming apparatuses such as a copier, a printer, a scanner, and a facsimile machine.

### First Embodiment

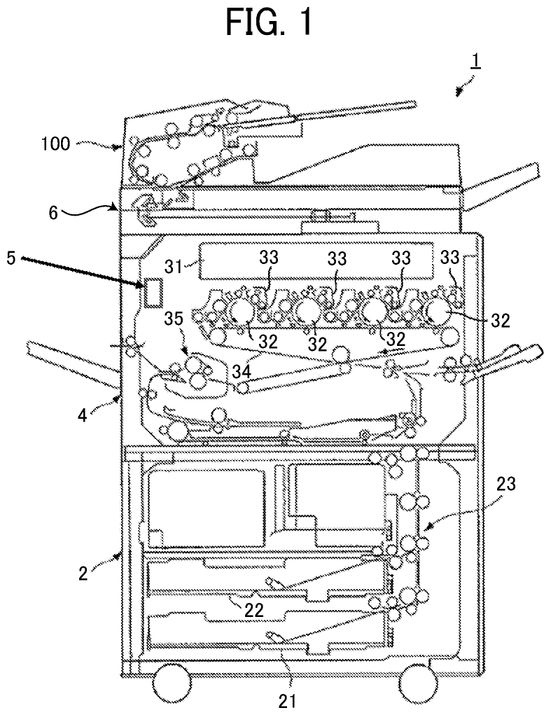

FIG. 1 is a diagram illustrating a configuration of an image forming apparatus 1 according to a first embodiment. As illustrated in FIG. 1, the image forming apparatus 1 includes an automatic document feeder (ADF) 100, a scanner 6, a sheet feeder 2, a plotter 4, and an image compression device 5. Details of the image compression device 5 will be described later.

The sheet feeder 2 includes sheet feeding cassettes 21 and 22 that store recording sheets of different sizes, and a sheet feeding device 23 including various rollers that transport a recording sheet stored in each of the sheet feeding cassettes 21 and 22 to an image formation position of the plotter 4.

The plotter 4 is an electrophotographic image forming unit including an exposure device 31, photoconductor drums 32, developing devices 33, a transfer belt 34, and a fixing device 35.

Note that the plotter 4 is not limited to a plotter using the electrophotographic scheme and may form an image using another scheme such as an inkjet scheme.

The plotter 4 prints, on a recording sheet, image data output from the scanner 6. More specifically, in the plotter 4, the exposure device 31 exposes the photoconductor drums 32 to light based on image data of an original read by an image reader in the scanner 6 to form latent images on the respective photoconductor drums 32. In the plotter 4, the developing devices 33 supply toner of different colors to the respective photoconductor drums 32 to develop the latent images. In the plotter 4, the developed images on the respective photoconductor drums 32 are transferred, via the transfer belt 34, onto a recording sheet supplied from the sheet feeder 2. In the plotter 4, the fixing device 35 then melts the toner of the transferred toner image on the recording sheet to fix the color image on the recording sheet.

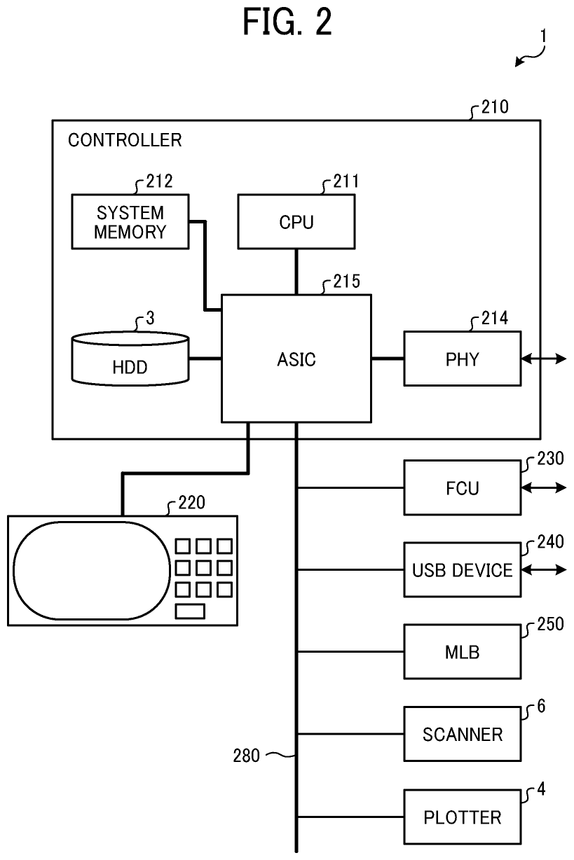

FIG. 2 is a block diagram illustrating an example of a hardware configuration of the image forming apparatus 1. As illustrated in FIG. 2, for example, the image forming apparatus 1 includes a controller 210, an operation panel 220, a facsimile control unit (FCU) 230, a Universal Serial Bus (USB) device 240, a media link board (MLB) 250, the scanner 6, and the plotter 4.

The operation panel 220 is a user interface that allows a user who uses the image forming apparatus 1 to input various settings and that displays various kinds of information to be presented to the user.

The FCU 230 is a control unit that controls the facsimile function of the image forming apparatus 1. The USB device 240 is a device connected to the image forming apparatus 1 by USB. The MLB 250 is a conversion board that converts the format of image data. The scanner 6 is an engine that reads an original. The plotter 4 is an engine that performs printing. The scanner 6 reads an original, so that an image to be processed is acquirable.

The controller 210 is a control device that controls operations of the image forming apparatus 1. As illustrated in FIG. 2, the controller 210 includes a central processing unit (CPU) 211, a system memory 212, a hard disk drive (HDD) 3, a physical layer (PHY) 214 of a communication circuit, and an application specific integrated circuit (ASIC) 215. The operation panel 220 is connected to the ASIC 215 of the controller 210. The FCU 230, the USB device 240, the MLB 250, the scanner 6, and the plotter 4 are connected to the ASIC 215 of the controller 210 through a data transfer bus 280.

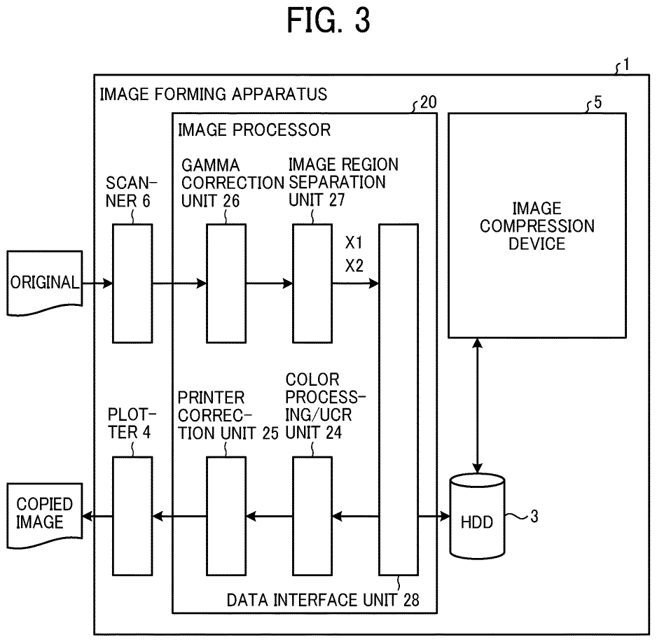

FIG. 3 is a block diagram illustrating an example of a functional configuration of the image forming apparatus 1. As illustrated in FIG. 3, the image forming apparatus 1 includes an image processor 20 and the image compression device 5, in addition to the scanner 6, the HDD 3, and the plotter 4.

Some or all of functional constituent elements of an image forming apparatus are implemented mainly by the controller 210 in the image forming apparatus 1. That is, the image processor 20 is implemented, for example, by the ASIC 215 of the controller 210. The image compression device 5 is implemented, for example, as a result of the CPU 211 of the controller 210 executing a predetermined program (software) stored in the system memory 212 or the HDD 3.

Note that the program may be provided after being recorded on a computer-readable recording medium such as a compact disc read-only memory (CD-ROM), a flexible disk (FD), a compact disc recordable (CD-R), or a digital versatile or digital video disc (DVD), in a file format installable or executable in the image forming apparatus 1. Alternatively, the program may be stored in a computer connected to a network such as the Internet and downloaded and provided via the network to the image forming apparatus 1. Alternatively, the program may be provided or distributed via the network such as the Internet. The program may be provided, for example, after being pre-installed in the system memory 212, the HDD 3, or the like of the image forming apparatus 1.

The scanner 6 reads an original fed by the ADF 100 to obtain image data. The scanner 6 transmits the obtained image data to the image processor 20.

The image processor 20 performs predetermined image processing on the image data obtained by the scanner 6. The image processor 20 sends the data having undergone the predetermined image processing to the image compression device 5.

The image processor 20 includes a gamma correction unit 26, an image region separation unit 27, a data interface unit 28, a color processing/under color removal (UCR) unit 24, and a printer correction unit 25.

The gamma correction unit 26 performs one-dimensional conversion (gamma correction processing) for adjusting a tone balance of each color on the image data (for example, 8-bit signal of each color of red (R), green (G), or blue (B) having undergone analog-to-digital conversion) obtained by the scanner 6. Density-linear signals (R, G, and B signals whose signal value indicating white is 0) resulting from the one-dimensional conversion are sent to the image region separation unit 27 and the data interface unit 28.

The image region separation unit 27 separates a plurality of regions corresponding to a plurality of attributes in the input image data (input image). For example, the image region separation unit 27 outputs, for each pixel of the image data, a text determination result (integrated determination result) X1 and a color determination result X2. The text determination result X1 indicates whether the pixel represents “text” or “non-text”. The color determination result X2 indicates whether the pixel is chromatic or achromatic.

Note that the text determination result X1 of “text” indicates that, for example, the pixel is a pixel of text. Since the determination about the text is performed independently from determination about the color, both chromatic text and achromatic text are determined to be “text”. The chromatic text indicates text represented mainly by a chromatic color (for example, color text). The achromatic text indicates text represented mainly by an achromatic color (for example, black text). The text determination result X1 of “non-text” indicates that, for example, the pixel is a pixel of a non-text portion such as a seal portion or a photograph.

In the description below, chromatic text and achromatic text may be referred to as color text and black text, respectively.

Note that units in which the determination results are output may be units of one pixel or units of one pixel block including a plurality of pixels. Description below will be given mainly of a case where the determination results are output in units of one pixel as an example.

The data interface unit 28 is an interface used when the text determination result X1 and the color determination result X2 output from the image region separation unit 27 and the image data (density linear signals) output from the gamma correction unit 26 are temporarily stored in the HDD 3. The data interface unit 28 outputs the image data having undergone the gamma correction and the text determination result X1 and the color determination result X2 received from the image region separation unit 27 to the color processing/UCR unit 24.

The color processing/UCR unit 24 selectively performs color processing and UCR processing, based on the text determination result X1 and the color determination result X2 for each pixel. For example, the color processing/UCR unit 24 converts 8-bit R, G, and B signals into image signals (8-bit signals of cyan (C), magenta (M), yellow (Y), and black (Bk)), and outputs the image signals. The image signals serve as control signals of the plotter 4.

The printer correction unit 25 performs gamma correction processing and dither processing (digital halftoning processing) reflecting tone characteristics of the plotter 4 on the image signals of C, M, Y, and Bk and outputs the resulting image signals to the plotter 4.

The image compression device 5 performs image compression processing on the image data having been obtained by the scanner 6 and having undergone the image processing in the image processor 20.

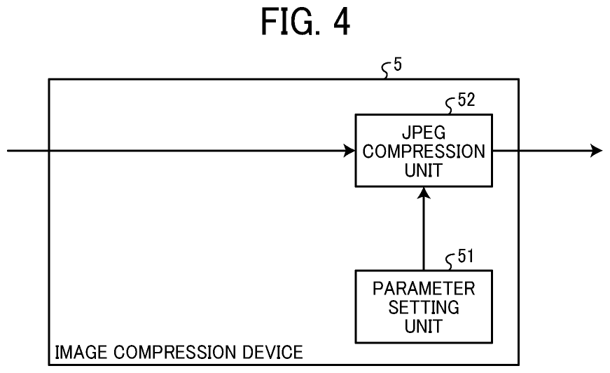

FIG. 4 is a block diagram illustrating a configuration of the image compression device 5. The image compression device 5 according to the present embodiment performs compression of color signals with a high image quality to suppress color mixing that occurs during the compression and sets a table that enables unintended coloring due to an optical factor to be removed through the compression. In this manner, the image compression device 5 implements both an increased OCR processing accuracy and a reduced file size. More specifically, the image compression device 5 sets an upper limit of parameters (coefficients) for color signals to be smaller than or equal to α to make the compression ratio low. In this manner, the image compression device 5 suppresses color mixing of a black portion and a color portion and increases the OCR accuracy. The image compression device 5 sets parameters (coefficients) of each of quantization tables for a brightness signal and a color signal to have a magnitude relationship. In this manner, the image compression device 5 reduces the file size.

As illustrated in FIG. 4, the image compression device 5 includes a parameter setting unit 51 and a Joint Photographic Experts Group (JPEG) compression unit 52.

The parameter setting unit 51 sets parameters (coefficients) in the JPEG compression unit 52.

The JPEG compression unit 52 receives the image data having undergone the predetermined image processing from the image processor 20 and receives the parameters (coefficients) from the parameter setting unit 51. Based on the text determination result X1 and the color determination result X2 output from the image region separation unit 27 and temporarily stored in the HDD 3, the JPEG compression unit 52 determines, in the image data having undergone the image processing, two regions of a “text portion” and a “seal-superimposed text portion” which will be described later. The JPEG compression unit 52 is a compression unit that preforms, in accordance with the parameters, JPEG compression processing on the image data in which the two regions of the “text portion” and the “seal-superimposed text portion” are determined. While the JPEG compression processing is JPEG in this example, any other image compression processing that is previously prepared is applicable.

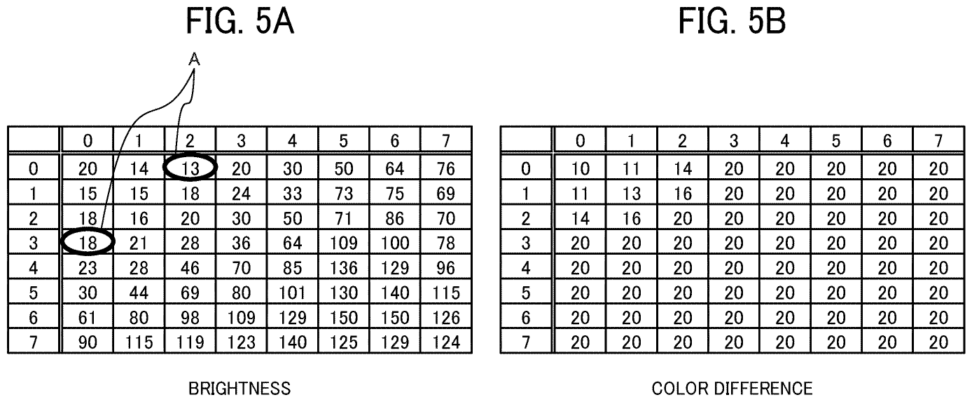

FIGS. 5A and 5B are diagrams schematically illustrating quantization tables used when the JPEG compression unit 52 performs JPEG compression. FIG. 5A illustrates an example of a quantization table used in compression on a brightness signal. FIG. 5B illustrates an example of a quantization table used in compression on a color signal (color difference). A quantization table includes parameters (coefficients) used in compression of frequency components. There are two quantization tables for a brightness signal (FIG. 5A) and for a color signal (FIG. 5B). Note that values of the parameters (coefficients) of each of the quantization tables illustrated in FIGS. 5A and 5B are an example.

Note that the parameters (coefficients) indicate respective elements of an 8×8 quantization table. Let (x, y) denotes coordinates in the quantization table. Then, “x” and “y” have any value of 0, 1, 2, 3, 4, 5, 6, and 7. The coordinates of a parameter (coefficient) at the upper-left corner of the 8×8 quantization table is defined as (0, 0). In the example of the quantization table illustrated in FIG. 5A, the parameter (coefficient) at (1, 0) is equal to “14”.

In each of the quantization tables, a pixel at (0, 0) is referred to as a DC component, and pixels at coordinates other than (0, 0) are referred to as AC components.

Note that as the parameters (coefficients) of the quantization table increase, the compression ratio increases. That is, as the parameters (coefficients) of the quantization table increase, the image quality decreases and consequently color mixing occurs.

One example of the original subjected to the OCR processing is an accounting form. Targets of the OCR processing in the accounting form include two regions of the “text portion” and the “seal-superimposed text portion”. Since a recognition hindrance factor in the OCR processing on the region of the “text portion” is just noise or the like, the difficulty of the OCR processing is low. Thus, the brightness signal for which a high image quality is not desired is compressed more than the color signals, so that the effect of an increased compression ratio is successfully obtained in the OCR processing on the region of the “text portion”.

On the other hand, in the region of the “seal-superimposed text portion”, since a text portion and a seal portion are close to each other, color mixing occurs between the text portion and the seal portion during compression. Thus, in binarization processing or dropout color processing which is preprocessing of the OCR processing, text is partially lost because of inappropriate processing such as removal of a text portion. This increases an occurrence probability of erroneous recognition. Thus, in the OCR processing on the region of the “seal-superimposed text portion”, the difficulty of the OCR processing of the text on which the seal or the like is superimposed is markedly high.

In compression, when the parameters of the quantization table for the color signal are set to small values, that is, the color signal is set to have a high image quality, color mixing between the black text and the color text and the partial loss that occurs during the dropout color processing are successfully suppressed. Thus, the accuracy of the OCR processing is successfully increased in the OCR processing on the region of the “seal-superimposed text portion”.

On the other hand, when a quantization table for a high image quality is simply used in compression of the color signal, the file size for the “text portion” is likely to increase. This is because when the quantization table for the high image quality is used for the color signal, the color signal (for unintended coloring) caused in the “text portion” by an optical factor such as noise, lens aberration, or misalignment caused by a sensor of the image reader in the scanner 6 remains after the compression. The unintended coloring due to the optical factor is likely to occur in a low-frequency region. By increasing the compression ratio for the low-frequency region of the color signal, the optically-induced unintended coloring caused in the “text portion” is successfully reduced. Thus, compression at the high image quality and the increased compression ratio are successfully implemented.

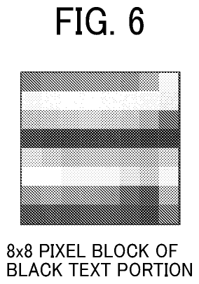

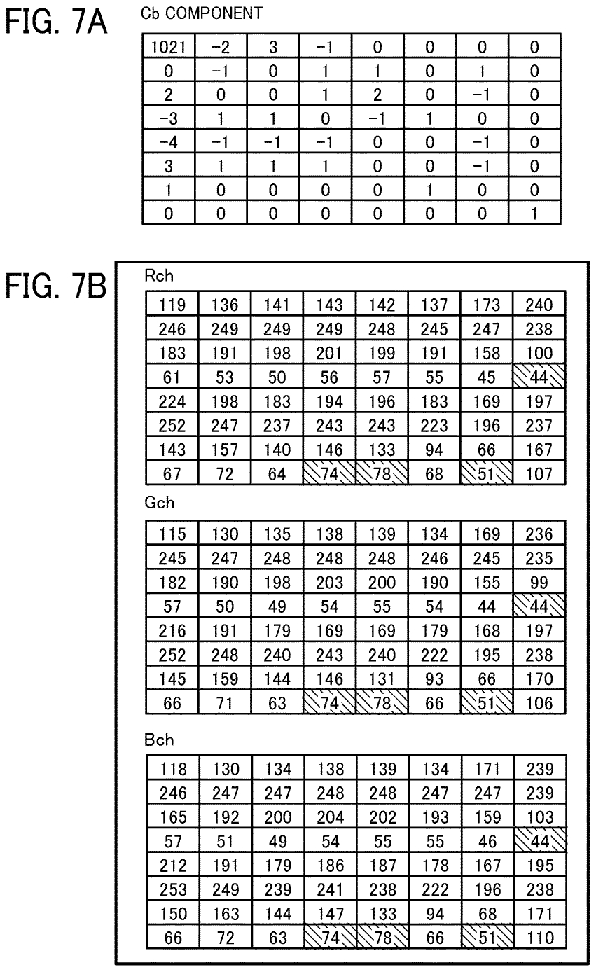

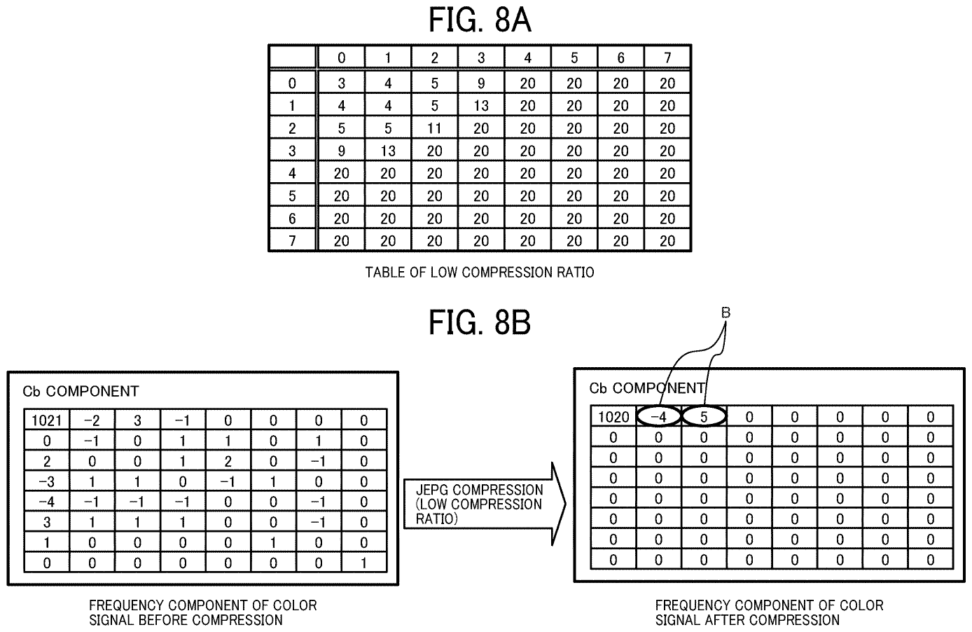

An example in which unintended coloring due to an optical factor remains will be described. FIG. 6 is a diagram illustrating an 8×8 pixel block (minimum units in JPEG compression processing) of a black text portion. FIGS. 7A and 7B are diagrams illustrating a frequency component and R, G, and B values of the color signals of the 8×8 pixel block of the black text portion. FIGS. 8A and 8B are diagrams illustrating an example of compression using a quantization table of a low compression ratio.

FIG. 6 is an example of an image having a large file size as a result of the color signal (for unintended coloring) not being removed through compression. The example illustrated in FIG. 6 is an image of 8×8 pixels extracted from the “text portion” which is the black text portion of the image data of the original having been obtained by the scanner 6 and having undergone the image processing in the image processor 20.

FIG. 7A illustrates the frequency component of the color signal of the 8×8 pixel block of the black text portion. FIG. 7B illustrates R, G, and B values of the 8×8 pixel block of the text portion. As indicated in FIGS. 7A and 7B, if all the pixels of the image illustrated in FIG. 6 have the same R, G, and B values, all the AC components are equal to “0”. However, the unintended coloring caused in the “text portion” by an optical factor such as noise, lens aberration, or misalignment caused by the sensor of the image reader in the scanner 6 remains in the image illustrated in FIG. 6. Thus, the AC components include non-“0” values. As hatched in FIG. 7B, there are four pixels having the same R, G, and B values. This indicates that the pixel block includes slight unintended coloring although the pixel block appears to be black at a glance.

FIGS. 8A and 8B illustrate an example in which JPEG compression with a low compression ratio is performed on the example of the frequency component illustrated in FIG. 7A. When compression is performed using a quantization table of a low compression ratio, for example, coefficients at (1, 0) and (2, 0) remain as indicated by the frequency component of the compressed color signal illustrated in FIGS. 8A and 8B. In encoding processing performed on the quantized frequency component, the file size can be reduced if the elements “0” are consecutive. However, when the quantization table of the low compression ratio is used, elements (indicated by circles B) remain. This hinders reduction of the file size.

Note that optically-induced unintended coloring due to an optical factor such as misalignment is likely to increase particularly at (1, 0) and (0, 1). Since many vertical and horizontal lines are used in text and easy-to-view text has a size of some extent, the frequency component is on the lower side. In the present embodiment, a region where an optically-induced color shift is likely to occur, i.e., a region of (1, 0) and (0, 1) among the AC components, is defined as a low-frequency region, whereas a region of the rest of the AC components is defined as a high-frequency region.

As described above, in OCR processing on a portion where the seal portion and the text portion are superimposed, compression of the color signals has a greater influence than compression of the brightness signal. Thus, a quantization table of a high image quality is desirably used in compression of the color signals that influence the accuracy of the OCR processing on the region of the “seal-superimposed text portion”.

For the region of the “text portion” where the difficulty of the OCR processing is low, the compression ratio for the low-frequency region of the color signals may be increased to make the image quality low. That is, in compression, for the region of the “text portion”, the values of the coefficients of the AC components of the quantization table for the brightness signal are set to be greater than the values of the coefficients of the AC components of the quantization table for the color signals to make the image quality low and thus to successfully reduce the file size.

Adopting such a relationship between the quantization table for the brightness signal and the quantization tables for the color signals successfully provides a file size reduction effect.

If the relationship that the values of the coefficients of the AC components of the quantization table for the brightness signal are greater than or equal to the values of the coefficients of the AC components of the quantization table for the color signals is satisfied by at least 90% of the coefficients of the quantization tables, a sufficient compression effect is provided. As illustrated in FIGS. 5A and 5B, for example, if the proportion of the coefficients (indicated by circles A) having a reversed magnitude relationship between the value of the coefficient of the AC component of the quantization table for the brightness signal and the value of the coefficient of the AC component of the quantization table for the color signal is about 10%, an increased accuracy of the OCR processing and a file size reduction effect can be sufficiently provided.

That is, the parameter setting unit 51 sets 90% or more of the coefficients of the AC components of the quantization table for the brightness signal to have values that are greater than or equal to the coefficients of the respective AC components of the quantization table for the color signal. Consequently, an increased OCR processing accuracy and an effect of an increased compression ratio are successfully provided.

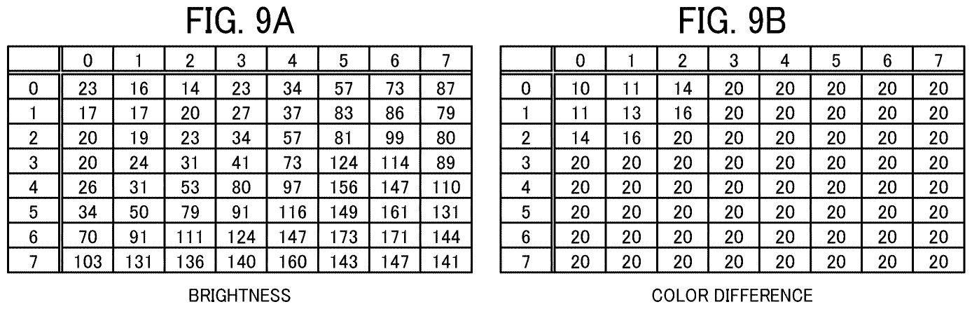

FIGS. 9A and 9B are diagrams schematically illustrating other quantization tables used when the JPEG compression unit 52 performs JPEG compression. FIG. 9A illustrates an example of the quantization table for the brightness signal. FIG. 9B illustrates an example of the quantization table for the color signal (color difference).

In the examples illustrated in FIGS. 9A and 9B, the parameter setting unit 51 sets values of the coefficients of all the AC components of the quantization table for the brightness signal to be greater than or equal to values of the respective coefficients of all the AC components of the quantization table for the color signal. In such a case, the compression effect can be further increased.

The coefficients (parameters) of the quantization table for the color signal have a feature that the low-frequency region and the high-frequency region of the color signal have a relationship below.

To achieve both the increased OCR processing accuracy and the reduced file size, the parameter setting unit 51 sets coefficients of the low-frequency region to values that are greater than or equal to α/2 and less than or equal to α, where α denotes an upper limit of the coefficients in the high-frequency region in the quantization table for the color signal. The reason why the coefficients of the quantization table for the color signal have such a feature will be described below.

The aforementioned “seal-superimposed text portion” is a representative example of a hindrance factor in the OCR processing. When the text portion and the seal portion are close to each other, the frequency component of the color signal occurs in both of the low-frequency region and the high-frequency region. Thus, when compression processing is performed on the region of the “seal-superimposed text portion”, color mixing occurs.

As the compression ratio increases, the file size decreases but the side effect of color mixing increases. Mixing of a color to black or mixing of black to another color adversely affects dropout color processing or binarization processing which is preprocessing of the OCR processing. As described above, as the coefficients of the quantization table increase, the compression ratio increases. That is, as the coefficients of the quantization table increase, the image quality decreases and color mixing occurs. Therefore, to reduce the influence of the side effect of unintended coloring due to compression, an upper limit is desirably set for the coefficients of the quantization table.

On the other hand, unintended coloring due to an optical factor less affects the frequency component of the color signal than unintended coloring caused in compression performed in the case where the text portion and the seal portion are superimposed or the like. Thus, by setting the coefficients of the quantization table to have values that are greater than or equal to a certain value, the frequency component of the unintended coloring due to the optical factor is successfully set to zero and the file size is successfully reduced.

In the compression processing of the related art, the low-frequency region is not compressed because the human visual sensation is sensitive to the low-frequency region.

In contrast, in the present embodiment, the compression ratio is increased to a level at which the image quality is satisfactory to the human visual sensation and the unintended coloring due to the optical factor is removable, to enable a file size reduction.

There is a sufficient difference in the level of the color signal between the frequency component of the unintended coloring due to the optical factor and the frequency component that occurs in the case where the text portion and the seal portion are superimposed. Therefore, the file size reduction is implemented if the coefficients of the high-frequency region of the quantization table and the coefficients of the low-frequency region of the quantization table have a doubled magnitude relationship. Specifically, when a denotes the upper limit of the coefficients of the high-frequency region that enables suppression of the unintended coloring for the frequency component in the case where the text portion and the seal portion are superimposed, the coefficients of the low-frequency region are desirably greater than or equal to α/2. To achieve both the increased OCR processing accuracy and the reduced file size, a relationship is desired in which the coefficients of the high-frequency region of the quantization table for the color signal are less than or equal to α and the coefficients of the low-frequency region of the quantization table for the color signal are greater than or equal to α/2 and less than or equal to α.

As described above, in the present embodiment, the upper limit of the parameters (coefficients) of the quantization table for the color signal are set to be less than or equal to α to make the compression ratio low, so that color mixing between a black portion and a color portion is successfully suppressed and the OCR accuracy is successfully increased. In addition, the parameters (coefficients) of the quantization table for each of the brightness signal and the color signal are set to have a magnitude relationship, so that the file size is successfully reduced. That is, in the present embodiment, a generic compressed image that achieves both an increased compression ratio and an increased OCR processing accuracy can be generated.

In the present embodiment, the coefficients of the low-frequency region of the quantization table are set to be greater than or equal to α/2, so that the color component of unintended coloring due to an optical factor in the text portion is successfully removed and the file size is successfully reduced.

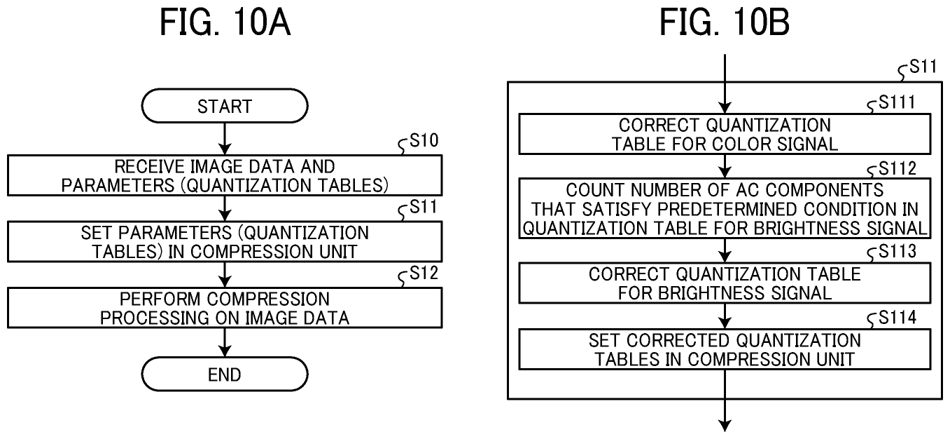

FIGS. 10A and 10B are flowcharts illustrating image compression processing performed by the image compression device according to the first embodiment.

The image compression device 5 receives the image data having undergone the image processing in the image processor 20 and the parameters (quantization tables) stored in the HDD 3 (S10). The parameters to be used may be quantization tables defined by default or may be original quantization tables.

The parameter setting unit 51 sets the parameters (quantization tables) in the JPEG compression unit 52 (S11). The parameter setting unit 51 sets the parameters such that the upper limit value of the coefficients of the quantization table for the color signal are less than or equal to α and 90% or more of the coefficients of the AC components of the quantization table for the brightness signal have values greater than or equal to values of the coefficients of the respective AC components of the quantization table for the color signal.

The JPEG compression unit 52 uses the set parameters (quantization tables) to perform compression processing on the image data (S12).

FIG. 10B is a flowchart illustrating sub-steps of step S11.

In a sub-step of step S11, the parameter setting unit 51 compares the value of each AC component included in the quantization table for the color signal with the predetermined upper limit α, and corrects the AC component to have a value that is less than or equal to α if the value of the AC component exceeds α (S111). Note that a may be a predetermined value or a value of an AC component of the quantization table for the brightness signal (for example, the value “20” of the parameter at coordinates (2, 2) in FIG. 5A). When the AC component of the color signal is corrected to have a value that is less than or equal to α, the AC component may be corrected to have a value of a or a value less than α.

The parameter setting unit 51 compares, for each AC component, a coefficient value qY(x, y) at coordinates (x, y) of the quantization table for the brightness signal with a coefficient value qC(x, y) at the coordinates (x, y) of the quantization table for the color signal, and counts the number of AC components that satisfy qY(x, y)<qC(x, y) (S112).

If the count result obtained in S112 is less than 90% of the number of AC components of the quantization table for the brightness signal, the parameter setting unit 51 corrects the values of the AC components of the quantization table for the brightness signal to make the count result be greater than or equal to 90% of the number of AC components of the quantization table for the brightness signal (S113). For example, when n AC components of the quantization table for the brightness signal are to be corrected, the parameter setting unit 51 selects n AC components from among the AC components of the quantization table for the brightness signal that satisfy qY(x, y)<qC(x, y), and corrects the values of the selected AC components to be equal to qC(x, y). As a result of this correction, the compression ratio of the brightness signal increases. However, the decrease in the image quality is successfully reduced if n AC components are selected in descending order of “x+y” from among the to-be-corrected AC components of the quantization table for the brightness signal, as compared with the case where n AC components are selected in ascending order of “x+y”. When the value qY(x, y) is corrected, the value may be corrected to be equal to qC(x, y) as described above or may be corrected to a value greater than qC(x, y).

The parameter setting unit 51 uses the quantization table for the color signal corrected in S111 and the quantization table for the brightness signal corrected in S113 to set the parameters (quantization tables) in the JPEG compression unit 52 (S114).

In the procedure of the processing performed by the image compression device 5 in the first embodiment, the values of the AC components of the quantization table for the brightness signal may be corrected in S113 such that the count result obtained in S112 indicates all the AC components (100% of the number of the AC components) of the quantization table of the brightness signal. In addition, if the value of the AC component of the low-frequency region of the quantization table for the color signal is less than or equal to α/2, a step of correcting the value to be greater than or equal to α/2 may be added in S111.

### Second Embodiment

A second embodiment will be described.

The second embodiment differs from the first embodiment in that generation of parameters is enabled. In the following description of the second embodiment, description of the same portion as the first embodiment is omitted and differences from the first embodiment will be described.

Since a color signal caused in the text portion by an optical factor such as misalignment is dependent on the performance or variation of the hardware, the coefficients suitable for compression slightly vary. The present embodiment allows an optimum setting for the low-frequency region to be set for each hardware model.

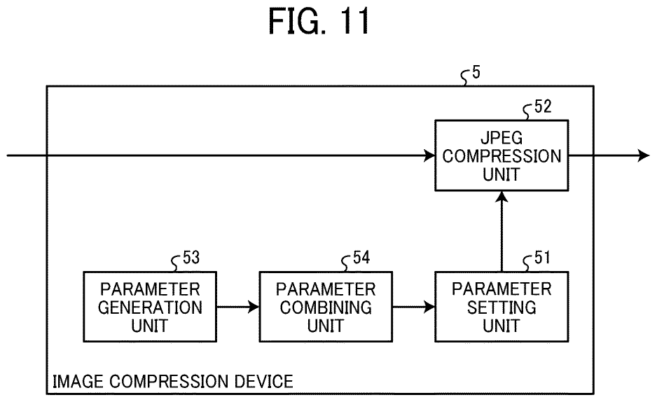

FIG. 11 is a block diagram illustrating a configuration of the image compression device 5 according to the second embodiment. The image compression device 5 according to the present embodiment further includes a parameter generation unit 53 and a parameter combining unit 54 in addition to the components of the image compression device 5 according to the first embodiment.

The parameter generation unit 53 generates coefficients (parameters) of quantization tables in accordance with a set compression ratio. That is, the parameter generation unit 53 generates two quantization tables having different compression ratios for the low-frequency region and the high-frequency region in accordance with the set compression ratio.

The parameter combining unit 54 generates a new quantization table in accordance with the quantization tables generated by the parameter generation unit 53. That is, the parameter combining unit 54 combines the two quantization tables having different compression ratios and generated by the parameter generation unit 53 to generate a new quantization table for use in compression.

Note that the “quantization tables having different compression ratios” generated by the parameter generation unit 53 may be quantization tables defined by default. The use of quantization tables defined by default makes generation of the quantization tables easy.

The parameter setting unit 51 sets the parameters of the new quantization table generated by the parameter combining unit 54 in the JPEG compression unit 52.

An example of generation of parameters will be described below.

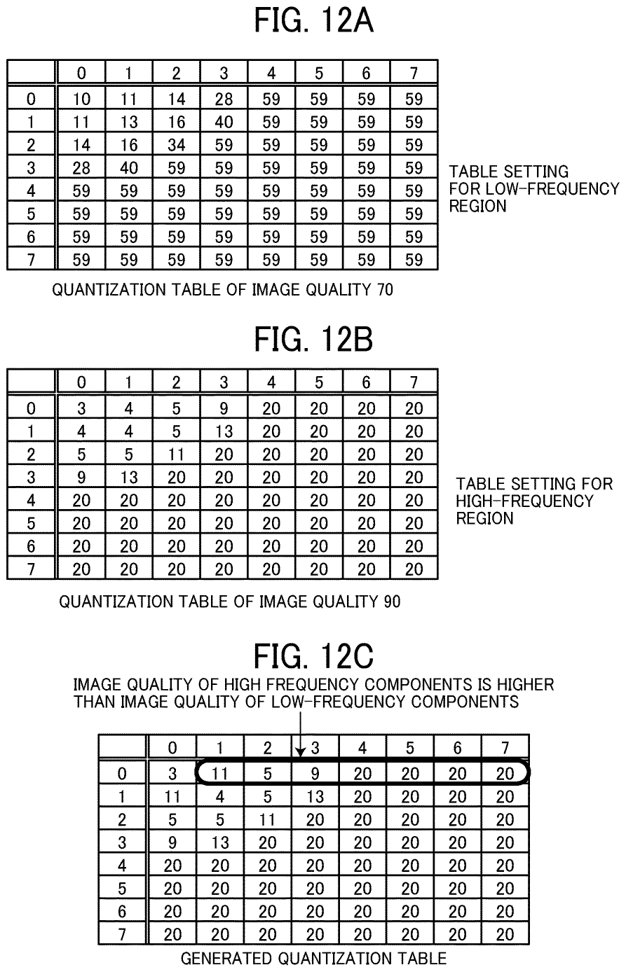

FIGS. 12A to 12C are diagrams illustrating an example of generation of parameters. A quantization table of “image quality 70” illustrated in FIG. 12A and a quantization table of “image quality 90” illustrated in FIG. 12B are quantization tables obtained based on the aforementioned quantization tables defined by default. In the present embodiment, the quantization tables defined by default are used. However, the quantization tables to be used are not limited to these quantization tables and may be original quantization tables.

The parameter generation unit 53 uses the quantization table of “image quality 70” to set the table for the low-frequency region and uses the quantization table of “image quality 90”, which is higher than the “image quality 70” in image quality, to set the table for the high-frequency region.

In the quantization tables generated by the parameter generation unit 53 and illustrated in FIG. 12C, when the quantization tables are viewed downward or rightward in FIG. 12C, some of the coefficients of the quantization table for the high-frequency region are smaller than the coefficients of the frequency components at (1, 0) and (0, 1) in the low-frequency region. That is, the coefficients of the frequency components in the high-frequency region implement a higher image quality than the coefficients of the frequency components in the low-frequency region.

On the other hand, the human visual sensation is more sensitive to a change in low frequency components and is less sensitive to a change in high frequency components. When the image quality increases from the low-frequency region to the high-frequency region, the components of the low-frequency region may be altered by the components of the high-frequency region. Consequently, an image that seems strange to the human visual sensation is generated.

To overcome the issue above, the parameter combining unit 54 corrects the quantization table under a condition below.

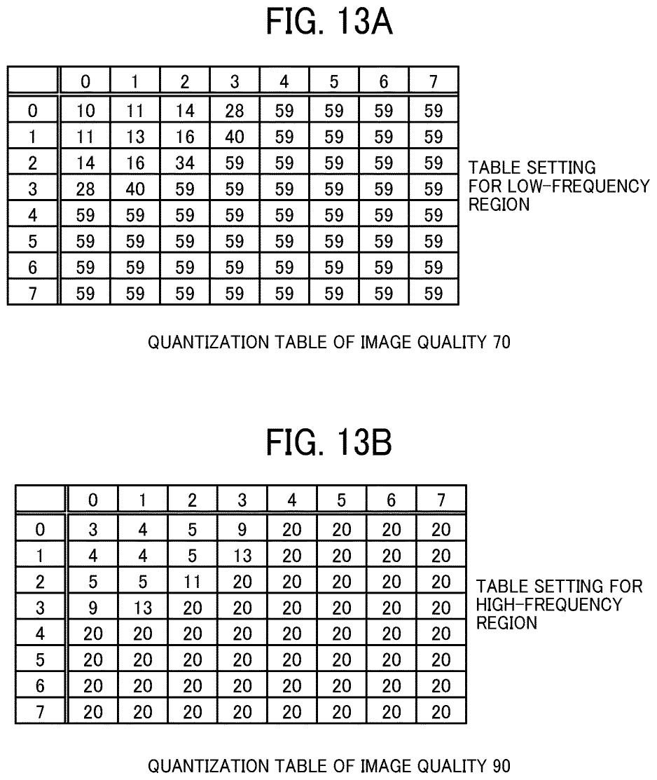

FIGS. 13A to 13D are diagrams illustrating an example of correcting the quantization table in generation of parameters. As illustrated in FIGS. 13A to 13C, when the quantization table includes a combination of one coefficient of an AC component and another coefficient that is located immediately on the right of or immediately under the one coefficient and that is smaller than the one coefficient, the parameter combining unit 54 corrects the value of the smaller coefficient to a value of a coefficient of a quantization table of a high compression ratio (low image quality). When the corrected value of the coefficient exceeds the upper limit α, the parameter combining unit 54 corrects the corrected value of the coefficient to the upper limit α. As illustrated in FIG. 13D, a hatched portion C of the corrected quantization table is a region that is corrected.

In this manner, an image that does not seem strange to the human visual sensation that is less sensitive to the change in high frequency and is more sensitive to the change in low frequency is generated.

As described above, in the present embodiment, different quantization tables are independently provided for the low-frequency region and the high-frequency region, and the quantization tables are combined to generate a new quantization table, so that an optimum setting for the low-frequency region is successfully set for each hardware model. Consequently, the parameters (coefficients) of the low-frequency region can be generated at a desired compression ratio, and thus a quantization table can be provided which implements both a reduced file size and an increased accuracy of OCR processing that can cope with a variation of unintended coloring due to lens aberration or misalignment caused by an individual difference of the image reader of the scanner 6.

### Third Embodiment

A third embodiment will be described.

The third embodiment differs from the first and second embodiments in that the JPEG compression unit 52 selectively performs sub-sampling processing (color component reduction processing). In the following description of the third embodiment, description of the same portion as the first and second embodiments is omitted and differences from the first and second embodiments will be described.

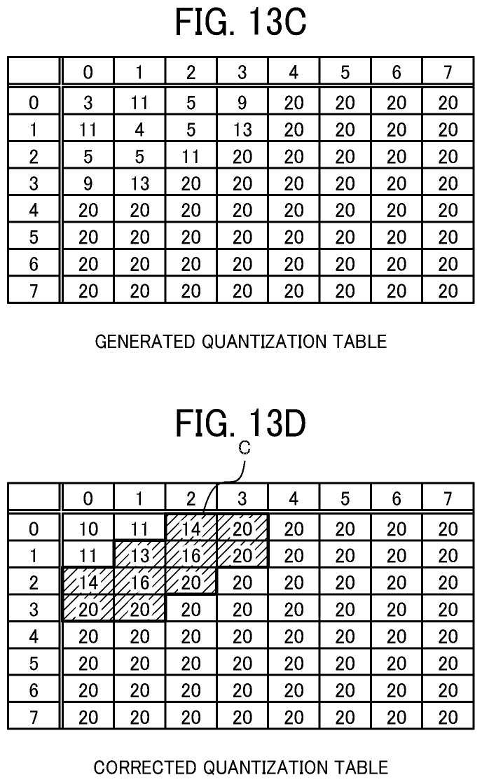

FIG. 14 is a diagram illustrating sub-sampling processing performed by the image compression device 5 according to the third embodiment. The JPEG compression unit 52 selectively performs sub-sampling processing. Sub-sampling is a method of reducing the color components, and reduces an amount of information and thus enables a file size reduction. In the related art, the color component reduction is performed since the human visual sensation is not sensitive to a change in the color components.

The sub-sampling processing illustrated in FIG. 14 is a method of reducing color components of 2×2 pixels to color components of one pixel. Note that the method of reducing the color components of 2×2 pixels to the color components of one pixel is merely an example. The color components may be reduced in the horizontal direction or in the vertical direction, or the color components in a broader range may be reduced.

The JPEG compression unit 52 can disable the sub-sampling processing. When the JPEG compression unit 52 disables the sub-sampling processing, color mixing between black text and color text due to reduction of color components can be suppressed, and a partial loss of the text can be suppressed in dropout color processing or the like. Thus, the effect of an increased OCR processing accuracy is successfully provided.

The JPEG compression unit 52 can enable the sub-sampling processing. When the JPEG compression unit 52 enables the sub-sampling processing, color mixing due to reduction of color components occurs. However, since it is common to perform the reduction processing in compression processing, the compression method can be supported by many kinds of generic OCR software.

### Fourth Embodiment

A fourth embodiment will be described.

The fourth embodiment differs from the first to third embodiments in that the compression techniques described in the first to third embodiments are used in diagnostic imaging using a color image. In the following description of the fourth embodiment, description of the same portion as the first to third embodiments is omitted and differences from the first to third embodiments will be described.

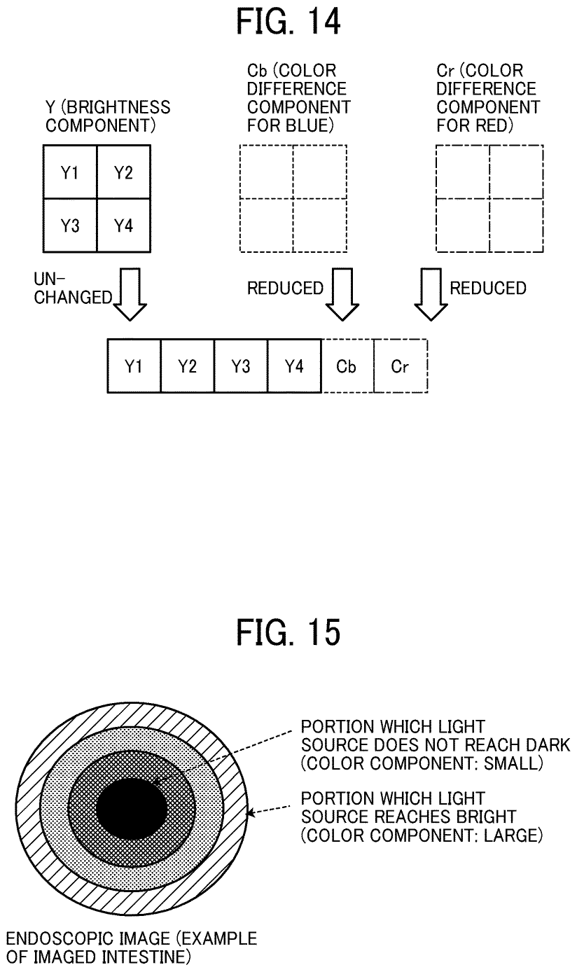

FIG. 15 is a diagram illustrating diagnostic imaging processing in an examination apparatus according to the fourth embodiment. FIG. 15 is an example of a color image of an organ of a person captured by an examination apparatus such as an endoscope.

As illustrated in FIG. 15, in the image captured by the examination apparatus such as an endoscope, a “portion which a light source does not reach” is not illuminated by light and thus is dark, whereas a “portion which the light source reaches” is illuminated by light and thus is bright and has large color components.

As described in the first to third embodiments, the compression techniques described herein are for greatly compressing the brightness component and reducing the compression effect for the color component to maintain the high image quality. Thus, in the present embodiment, in diagnostic imaging performed with an examination apparatus such as an endoscope, the result obtained by the examination apparatus is generated according to any of the compression techniques described herein. A high image quality is maintained in an image region of the “portion which the light source reaches”, which is desirably used for diagnosis, whereas a high compression ratio is achieved in an image region of the “portion which the light source does not reach”, which is not used for diagnosis. Consequently, a compressed image with a high compression effect is successfully obtained.

Although the embodiments of the present disclosure have been described above, the above-described embodiments are presented as examples and are not intended to limit the scope of the present disclosure. Such novel embodiments may be carried out in various other modified forms. Various omissions, substitutions, and changes may be made without departing from the gist of the present disclosure. Such novel embodiments and modifications thereof are within the scope and gist of the present disclosure and are also within the scope of the claims and the equivalent thereof. The elements of different embodiments or modifications may be combined with each other as appropriate.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol/Internet Protocol (TCP/IP) signal carrying computer code over an IP network, such as the Internet. The carrier medium may also include a storage medium for storing processor readable code such as a floppy disk, a hard disk, a compact disc read-only memory (CD-ROM), a magnetic tape device, or a solid state memory device.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

This patent application is based on and claims priority to Japanese Patent Application Nos. 2023-013552, filed on Jan. 31, 2023, and 2023-205681, filed on Dec. 5, 2023, in the Japan Patent Office, the entire disclosure of which is hereby incorporated by reference herein.

### REFERENCE SIGNS LIST

1 image forming apparatus
4 plotter (image forming unit)
5 image compression device
51 parameter setting unit
52 JPEG compression unit (compression unit)
53 parameter generation unit
54 parameter combining unit

1. An image compression device comprising:
compression circuitry configured to receive image data and parameters for use in compression, and perform compression processing on the image data based on information on the image data and the parameters using a quantization table for a brightness signal and a quantization table for a color signal; and
parameter setting circuitry configured to set the parameters in the compression circuitry,
wherein the parameter setting circuitry;
sets an upper limit of the parameters of the quantization table for the color signal to a value that is less than or equal to α, and
sets 90% or more of the parameters of AC components of the quantization table for the brightness signal to have values that are greater than or equal to the respective parameters of AC components of the quantization table for the color signal.

2. The image compression device according to claim 1, wherein:
the parameter setting circuitry is configured to set a value of each of the parameters of all the AC components of the quantization table for the brightness signal to be greater than or equal to a value of a corresponding parameter of the parameters of all the AC components of the quantization table for the color signal.

3. The image compression device according to claim 1, wherein:
the parameter setting circuitry is configured to set parameters of a low-frequency region of the quantization table for the color signal to have values that are greater than or equal to α/2 and less than or equal to α, where α denotes the upper limit of parameters of a high-frequency region of the quantization table for the color signal.

4. The image compression device according to claim 1, further comprising:
parameter generation circuitry configured to generate, in accordance with a set compression ratio, two quantization tables of different compression ratios for a low-frequency region and a high-frequency region; and
parameter combining circuitry configured to combine the two quantization tables generated by the parameter generation circuitry to generate a new quantization table for use in compression,
wherein the parameter setting circuitry sets parameters of the new quantization table generated by the parameter combining circuitry in the compression circuitry.

5. The image compression device according to claim 4, wherein:
in a case where the new quantization table includes a combination of one coefficient of an AC component and another coefficient that is located immediately on right of or immediately under the one coefficient and that is smaller than the one coefficient, the parameter combining circuitry corrects a value of said another coefficient to a value of a coefficient in the quantization table of a higher compression ratio among the two quantization tables, and
in a case where the corrected value of said another coefficient exceeds the upper limit α, the parameter combining circuitry corrects the corrected value of said another coefficient to the upper limit α.

6. The image compression device according to claim 1, wherein:
the compression circuitry selectively performs sub-sampling processing for reducing color components.

7. An image forming apparatus comprising:
the image compression device according to claim 1; and
an image forming unit configured to print image data compressed by the image compression device.

8. An examination apparatus comprising:
the image compression device according to claim 1.

9. An image compression method comprising:
receiving image data and parameters for use in compression;
performing compression processing on the image data based on information on the image data and the parameters using a quantization table for a brightness signal and a quantization table for a color signal; and
setting the parameters,
wherein the setting includes:
setting an upper limit of the parameters of the quantization table for the color signal to a value that is less than or equal to α, and
setting 90% or more of the parameters of AC components of the quantization table for the brightness signal to have values that are greater than or equal to the respective parameters of AC components of the quantization table for the color signal.

10. A non-transitory computer readable recording medium storing a program which causes a computer to perform an image compression method, the method comprising:
receiving image data and parameters for use in compression;
performing compression processing on the image data based on information on the image data and the parameters using a quantization table for a brightness signal and a quantization table for a color signal; and
setting the parameters,
wherein the setting includes:
setting an upper limit of the parameters of the quantization table for the color signal to a value that is less than or equal to α, and
setting 90% or more of the parameters of AC components of the quantization table for the brightness signal to have values that are greater than or equal to the respective parameters of AC components of the quantization table for the color signal.
